(19) United States
(12) Patent Application Publication
(10) Pub. No.: US 2016/0137240 A1
(43) Pub. Date: May 19, 2016

(54) Track Pads and Track Assembly

(71) Applicant: Caterpillar Inc., Peoria, IL (US)

(72) Inventor: Tom Oertley, Peoria, IL (US)

(73) Assignee: CATERPILLAR INC., Peoria, IL (US)

(21) Appl. No.: 14/886,329

(22) Filed: Oct. 19, 2015

Related U.S. Application Data
(60) Provisional application No. 62/081,123, filed on Nov. 18, 2014.

(51) Int. Cl. B62D 55/28; B62D 55/21; B62D 55/20

(52) U.S. Cl. CPC B62D 55/28; B62D 55/202; B62D 55/21

(57) ABSTRACT

A track pad for a machine having a track assembly. The track pad includes a body having top, bottom, first end, second end, and central portions. The track pad includes a ground engaging surface on the bottom, and first and second flat link engaging surfaces on the top. The first link engaging surface is disposed at the first end and the second link engaging surface is disposed at the second end. The track pad includes a lug protruding from the central portion between the first and second link engaging surfaces. The lug extends above the first and second link engaging surfaces so as to engage a drive wheel of the machine. A fastener hole is formed through the body between the first link engaging surface and the ground engaging surface, and a fastener hole is formed through the body between the second link engaging surface and the ground engaging surface.

### CROSS-REFERENCE TO RELATED APPLICATIONS

This patent application claims the benefit of priority to U.S. Provisional Patent Application No. 62/081,123, filed on Nov. 18, 2014, and entitled “Track Pads and Track Assembly,” which is incorporated in its entirety herein by reference.

### TECHNICAL FIELD

This patent disclosure relates generally to track pads and, more particularly to track pads for a track assembly.

### BACKGROUND

Various types of mining and construction machines, such as tractors, bulldozers, backhoes, excavators, motor graders, and mining trucks commonly use tracks as a method of machine propulsion. Such track-type mobile machines use track-type treads located at either side of the machine. The tracks each include a chain having links pinned end-to-end to form a loop that extend around main drive wheels of the machine. The wheels drive the tracks around the wheel frames to move the machine in the desired direction.

Traditionally, track-type treads comprise a plurality of crawler shoes made up of a ground engaging pad and a pair of links connected to the pads and joined to adjacent links with pins. Commonly, the links and ground engaging pad that make up the crawler shoe are forged or cast together as a single component. Due to high impact loads encountered by crawler shoes during machine operation, traditional crawler shoes require excess material to overcome demanding conditions. Even using additional material, crawler shoes are subject to wear and need to be periodically replaced. Excessive crawler shoe replacement and maintenance can result excessive machine downtime and decreased operating efficiency.

A track assembly is needed that overcomes one or more of the problems set forth above.

### SUMMARY

The disclosure describes, in one aspect, a track pad for a machine having a track assembly. The track pad includes a body having a top portion, a bottom portion, a first end portion, a second end portion, and a central portion between the first and second end portions. The track pad includes a ground engaging surface defined on the bottom portion, and first and second substantially flat and co-planar link engaging surfaces defined on the top portion. The first link engaging surface is disposed at the first end portion and the second link engaging surface is disposed at the second end portion. The track pad also includes a lug protruding from the central portion between the first and second link engaging surfaces. The lug extends above the first and second link engaging surfaces with respect to the ground engaging surface so as to periodically engage a drive wheel of the machine. At least one fastener hole is formed through the body between the first link engaging surface and the ground engaging surface, and at least one fastener hole is formed through the body between the second link engaging surface and the ground engaging surface.

In another aspect, the disclosure describes a track assembly for a machine. The track assembly includes a plurality of track pads. Each track pad includes a ground engaging surface opposite first and second co-planar link engaging surfaces, and a lug protruding between the link engaging surfaces above the link engaging surfaces with respect to the ground engaging surface. The lug is configured to periodically engage a drive wheel of the machine. The track assembly also includes a plurality of first and second pairs of links. The first pairs of links are disposed on the first link engaging surfaces of the track pads and the second pairs of links are disposed on the second link engaging surfaces of the track pads. The first and second pairs of links are disposed on opposite sides of the lugs from one another. The track assembly also includes a plurality of pins connecting adjacent first pairs of links end to end so as to form a first endless chain, and connecting adjacent second pairs of links end to end so as to form a second endless chain. The first and second endless chains connect adjacent track pads in an endless loop.

In another aspect, the disclosure describes a track pad for a machine having a track assembly. The track pad includes a body having a top portion, a bottom portion, a first end portion, a second end portion, and a central portion between the first and second end portions. The track pad includes a ground engaging surface defined on the bottom portion. The ground engaging surface includes a cavity portion defined in a bottom cavity formed into the bottom portion of the body and an edge portion surrounding the bottom cavity. The track pad includes first and second substantially flat and co-planar link engaging surfaces defined on the top portion. The first link engaging surface is disposed at the first end portion and the second link engaging surface is disposed at the second end portion. The track pad also includes a lug protruding from the central portion between the first and second link engaging surfaces. The lug extends above the first and second link engaging surfaces with respect to the ground engaging surface so as to periodically engage a drive wheel of the machine. The lug includes a roller path surface disposed above the first and second link engaging surfaces with respect to the ground engaging surface, and first and second arms that extend above the roller path surface. The first arm is adjacent the first link engaging surface and the second arm is adjacent the second link engaging surface such that the roller path surface is disposed between the first and second arms. At least one fastener hole is formed through the body between the first link engaging surface and the cavity portion of the ground engaging surface and at least one fastener hole is formed through the body between the second link engaging surface and cavity portion of the ground engaging surface.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view illustration of an exemplary track-type machine;

FIG. 2 is a perspective view of a portion of a track assembly in accordance with the disclosure;

FIG. 3 is a perspective view taken from the top, front, and left side of a track pad in accordance with the disclosure;

FIG. 4 is a perspective view taken from the bottom, front, and left side of the track pad of FIG. 3;

FIG. 5 is a front view of the track pad of FIG. 3;

FIG. 6 is a left side elevation view of the track pad of FIG. 3;

FIG. 7 is a bottom view of the track pad of FIG. 3;

FIG. 8 is a top view of the track pad of FIG. 3.

FIG. 9 is a front sectional view of the track pad of FIG. 3 as indicated in FIG. 8; and

FIG. 10 is a left side sectional view of the track pad of FIG. 3 as indicated in FIG. 7.

### DETAILED DESCRIPTION

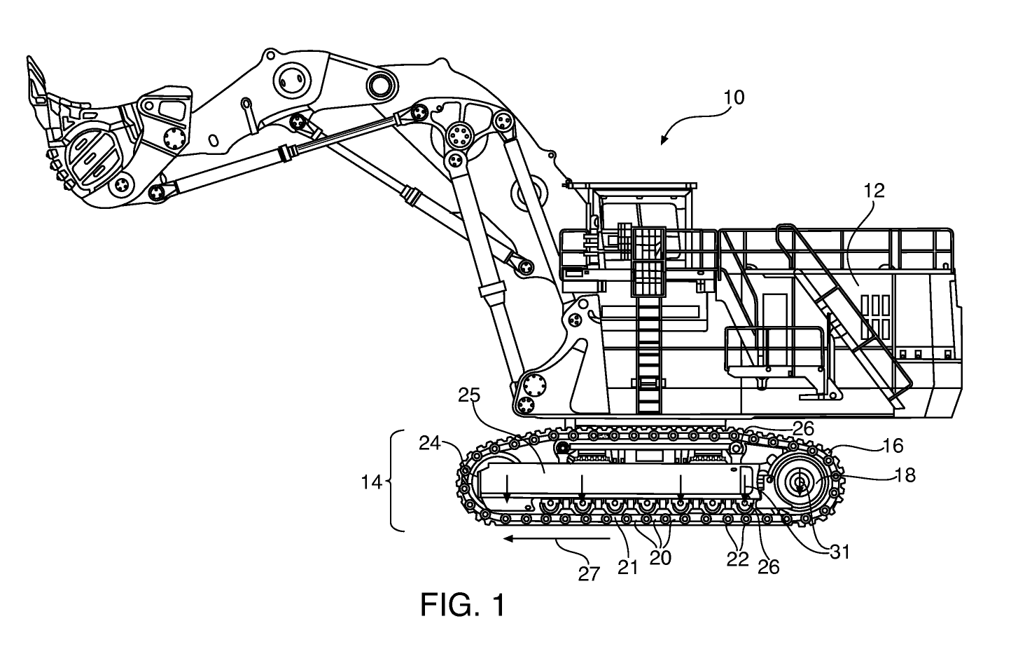

This disclosure relates to track-type treads and track pads incorporated in track-type treads used in various types of tractors, bulldozers, backhoes, excavators, motor graders, mining trucks, and other construction machinery. FIG. 1 illustrates a track-type machine 10 having an engine 12 supported by a frame and configured to drive a tracked undercarriage 14. While FIG. 1 shows a machine 10 in the form of a hydraulic excavator, it is contemplated that the machine could be any type of material moving or construction machine, such as a front shovel, a dozer, a loader, or another material moving machine.

The undercarriage 14 can include parallel track assemblies 16 that are disposed at opposing sides of the machine 10 and driven by the engine 12 via corresponding drive wheels 18 (only one track assembly 16 and one drive wheel 18 are shown in FIG. 1). Each track assembly 16 can include a plurality of track pads 20 arranged end-to-end and connected by a pair of endless chains 21, 23 (only one endless chain 21 shown in FIG. 1) to form an endless loop. The track assemblies 16 may be wrapped around corresponding drive wheels 18, one or more idler wheels, and at least one roller 26. Pins 22 can connect pairs of links to form the endless chains 21, 23. The drive wheels 18 can engage the track pads 20 and thereby transmit torque from the engine 12 to track assemblies 16. The idler wheel 24 and the rollers 26 may guide the track assemblies 16 in a general elliptical trajectory around the drive wheels 18. A tensioner 25 may be disposed between the idler wheel 24 and the drive wheel 18 to push the idler wheel and the drive wheel apart and thereby maintain a desired tension of the track assembly 16. The track pads 20 may function to transmit the torque from drive wheels 18 as a driving linear (tractive) force 27 into a ground surface. The weight of the machine 10 can be transmitted from drive wheel 18, idler wheel 24, and rollers 26 through track pads 20 as a bearing force 31 into the ground surface.

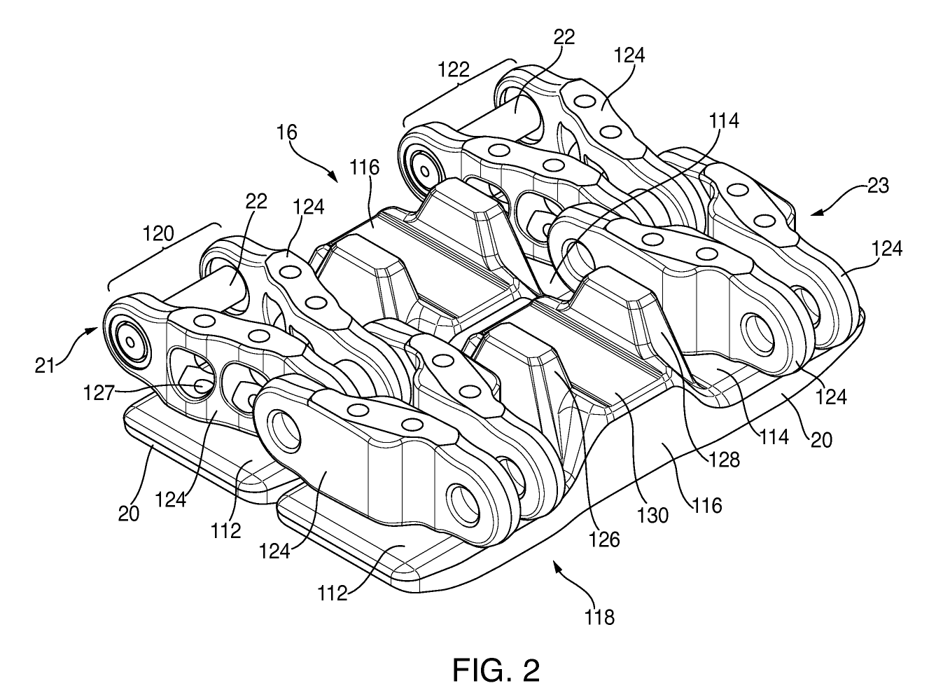

FIG. 2 shows a portion of a track assembly 16. The portion of the track assembly 16 shown in FIG. 2 shows only two track pads 20 connected by portions of first endless chain 21 and second endless chain 23, but it is to be understood that the portions shown in FIG. 2 are merely for ease of illustration and that an entire endless loop track assembly is contemplated. As illustrated, FIG. 2 shows two track pads 20 arranged adjacent to one another. Each track pad 20 can include a first link engaging surface 112, a second link engaging surface 114, and a lug 116 protruding from between the first and second link engaging surfaces. The lugs 116 can each include a first arm 126 and a second arm 128 that protrude above a roller path surface 130. The lug 116 can protrude vertically so as to enable the lug to periodically engage with the drive wheel 18 of the machine 10 in order drive the track assembly 16. The track pads 20 can also each include ground engaging surface 118 disposed on opposite the first and second link engaging surfaces 112, 114.

The endless chains 21, 23 can be made up of a plurality of first pairs of links 120 and a plurality of second pairs of links 122 arranged end-to-end. A plurality of links 124 make up the first and second pairs of links 120, 122. Although FIG. 2 shows links 124 that form a tapering pair of links, other shapes of links 124 are contemplated herein. A plurality of pins 22 can connect adjacent pairs of links 120, 122 in a pivotal connection. The set of first pairs of links 120 can be disposed on the first link engaging surface 112, and the set of second pairs of links 122 can be disposed on the second link engaging surface 114. The links 124 making up the first and second pairs of links 120, 122 can be mounted to the respective first and second link engaging surfaces 112, 114 using fasteners 127, such as bolts, screws, rivets, or any other suitable fasteners. Thus, in the embodiment illustrated in FIG. 2, the lugs 116 of the track pads 20 can engage the drive wheels 18 of the machine 10, and the first and second endless chains 21, 23 create a connection between adjacent track pads.

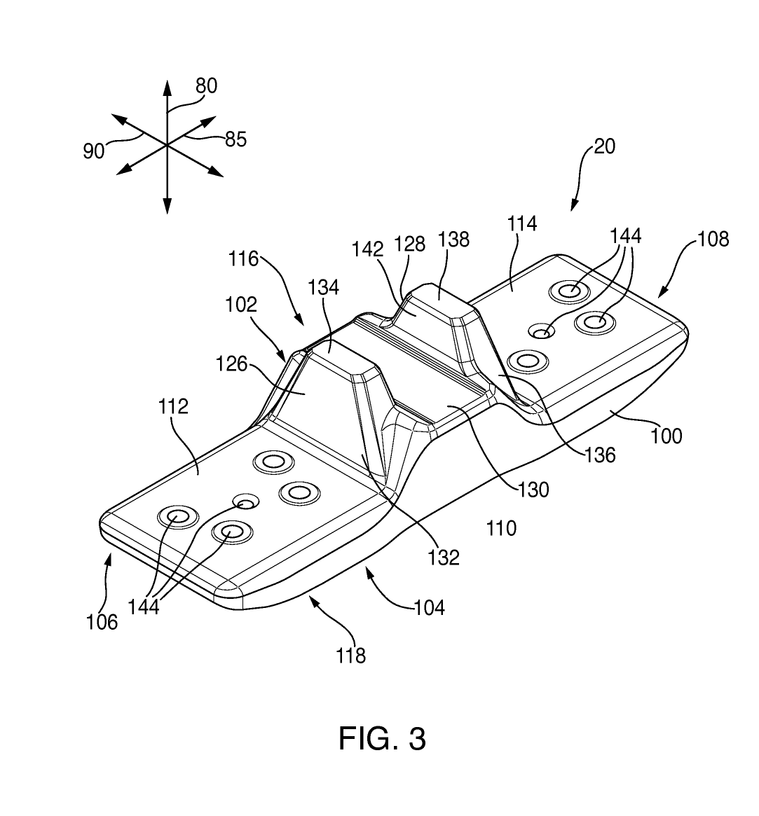

FIGS. 3-10 show several different views of one of the plurality of track pads 20 that can be included in the track assemblies 16. For the purpose of illustration and reference, the figures indicate a set of axes including a normal axis 80, a lateral axis 85, and a longitudinal axis 90. Referring to FIG. 3, the track pad 20 includes a body 100 that can include a top portion 102, a bottom portion 104, a first end portion 106, a second end portion 108, and a central portion 110 that can be disposed between the first and second end portions. The ground engaging surface 118 can be defined on the bottom portion 104 of the body 100. The first link engaging surface 112 can be defined on the top portion 102 at the first end portion 106, and the second link engaging surface 114 can be disposed on the top portion 102 at the second end portion 108. In certain embodiments, the first and second link engaging surfaces 112, 114 can be substantially aligned along the longitudinal axis 90 and the lateral axis 85. In some embodiments, the first and second link engaging surfaces 112, 114 can be co-planar, but other configurations are also contemplated.

The lug 116 can protrude from the central portion 110 of the body 100 of the track pad 20, between the first and second link engaging surfaces 112, 114. The lug 116 can extend above the first and second link engaging surfaces 112, 114 with respect to the ground engaging surface 118 along the normal axis 80. The lug 116 can have a first arm 126, a second arm 128, and a roller path surface 130. The roller path surface 130 can be disposed between the first and second arms 126, 128. The first and second arms 126, 128 project above the roller path surface 130 with respect to the first and second link engaging surfaces 112, 114 along the normal axis 80. A channel can be formed between a first inner arm surface 140 and a second inner arm surface 142 of the respective first and second arms 126, 128, and above the roller path surface 130. The first arm 126 can have a first arm base 132 adjacent the first link engaging surface 112. The first arm 126 can tapers upwardly so as to form a first arm top surface 134 at a distal end of the first arm that can be narrower than the first arm base 132. Similarly, the second arm 128 can have a second arm base 136 adjacent the second link engaging surface 114. The second arm 128 can taper upwardly so as to form a second arm top surface 138 at a distal end of the second arm that can be narrower than the second arm base 136. Although the first and second arm top surfaces 134, 138 can have a rounded surface shape, it is also contemplated that the first and second arm top surfaces 134, 138 can be substantially co-planar and aligned substantially along the longitudinal axis 90 and the lateral axis 85.

Although the figures depict an embodiment of the track pad with a lug 116 including a roller path surface 130 disposed between first and second arms 126, 128, other lug configurations are contemplated. For example, the lug could have a single-arm construction in which single arm is configured to engage a drive wheel of the machine. In some embodiments, the lug can include two roller paths on opposite sides of a single arm, and roller paths with curved or flat surfaces. Other suitable lug configurations are also contemplated to engage with the machine's drive wheel, such as a roller path surface that extends above the arms of the lug.

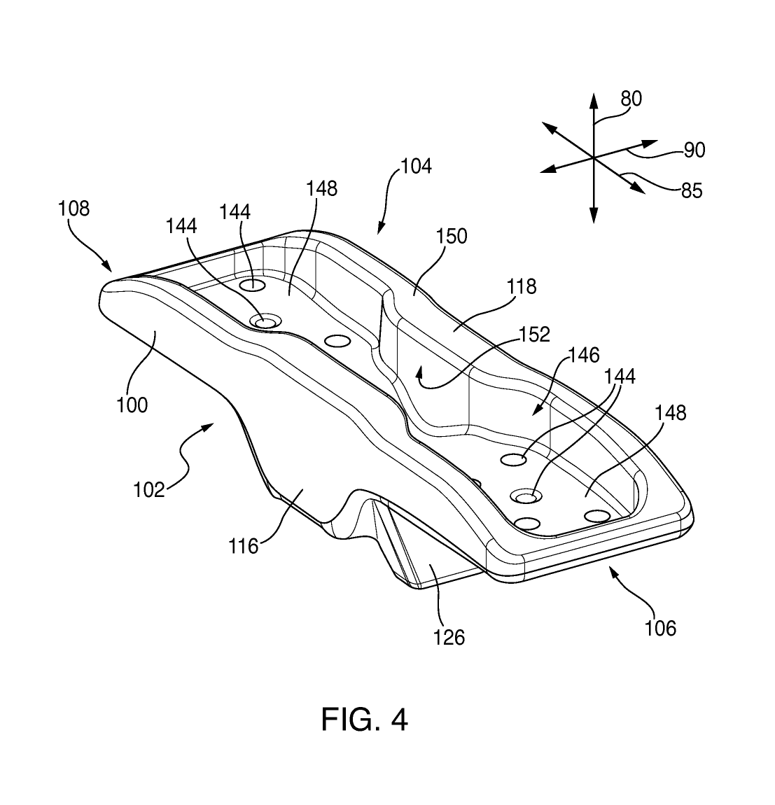

Referring now to FIG. 4, the track pad 20 is shown from a bottom perspective view. A bottom cavity 146 can be formed into the bottom portion 104 of the body 100. A cavity portion 148 of the ground engaging surface 118 can be defined along the base of the bottom cavity 146, and an edge portion 150 of the ground engaging surface 118 can be defined along the bottom portion 104 substantially surrounding the bottom cavity. A cavity wall surface 152 can be formed on the ground engaging surface 118 between the cavity portion 148 and the edge portion 150.

As shown in both FIG. 3 and FIG. 4, some embodiments can include at least one fastener hole 144 formed through the body 100 between the first link engaging surface 112 and the ground engaging surface 118, and at least one fastener hole can be formed through the body between the second link engaging surface 114 and the ground engaging surface 118. In some embodiments, such as the embodiment illustrated in FIG. 4, fastener holes 144 can be formed through the body 100 between the first and second link engaging surfaces 112, 114 and the cavity portion 148 of the ground engaging surface 118. While the embodiment illustrated in FIG. 3 and FIG. 4 show five fastener holes 144 formed through the body 100 of the track pad 20 at each of the first link engaging surface 112 and the second link engaging surface 114, it is contemplated that other numbers of fastener holes can be used in other embodiments.

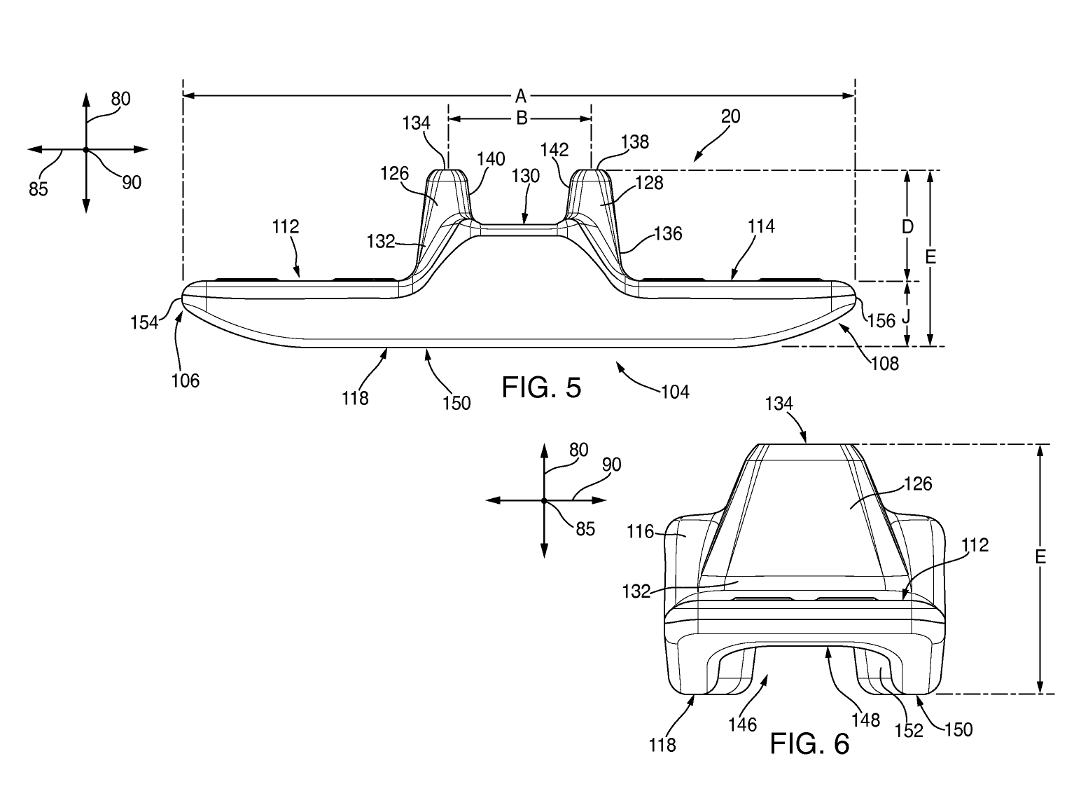

Referring now to FIG. 5, the track pad 20 can have an overall body width A measured along the lateral axis 85. The body width A can be measured between a first body end 154 and a second body end 156. The track pad 20 can also have an arm width B measured along the lateral axis 85 between the first arm 126 and the second arm 128. As shown in FIGS. 5 and 6, the track pad 20 can have an overall body height E measured along the normal axis 80 between the edge portion 150 of the ground engaging surface 118 and the first and second arm top surfaces 134, 138 of the respective first and second arms 126, 128. As shown in FIG. 5, the body height E can be broken into an arm height D and a linking height J, both measured along the normal axis 80. The arm height D can be measured between either of the first or second link engaging surfaces 112, 114 and either of the first or second arm top surfaces 134, 138. The linking height J can be measured between the edge portion 150 of the ground engaging surface 118 and either the first or second link engaging surface 112, 114. As shown in FIG. 8, the track pad 20 can have an overall body length C measured along the longitudinal axis 90. The body length C can be measured between a front end 158 of the body 100 and a rear end 160 of the body.

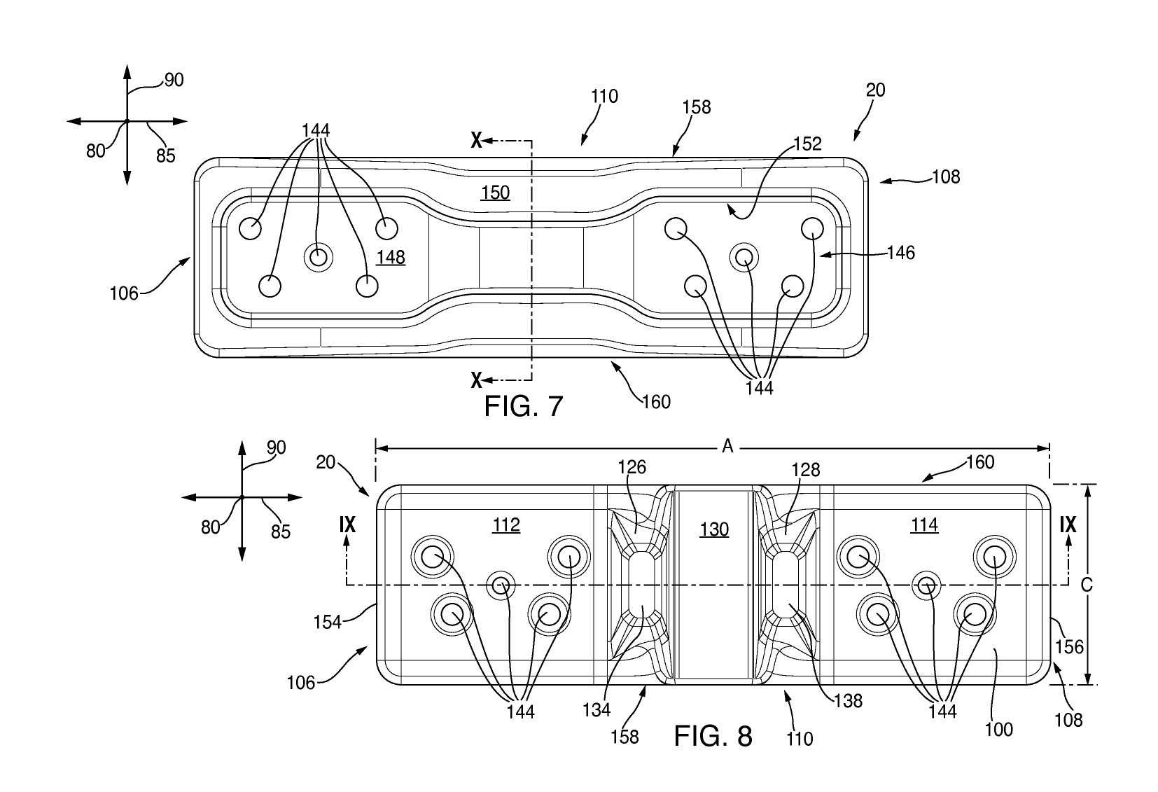

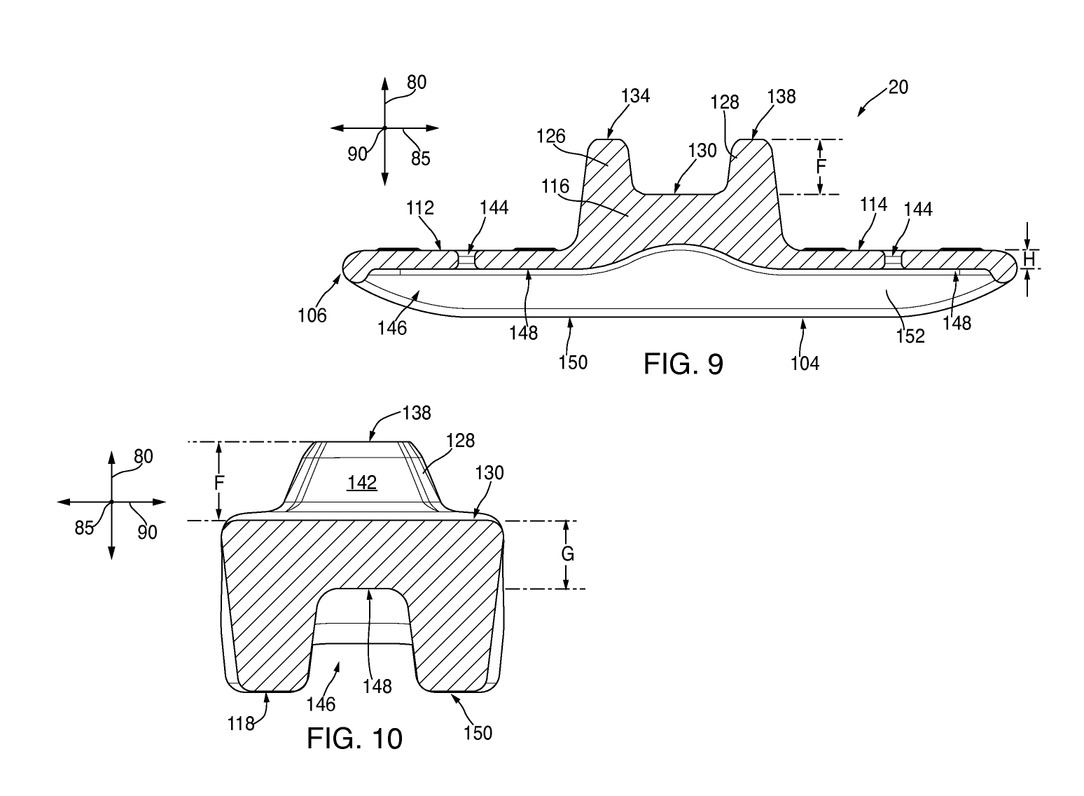

FIG. 9 illustrates a cross section of the track pad 20 as indicated in FIG. 8. The cross section shown in FIG. 9 is taken along a plane defined by the normal axis 80 and the lateral axis 85. FIG. 10 illustrates a cross section of the track pad 20 as indicated in FIG. 7. The cross section shown in FIG. 10 is taken along a plane defined by the normal axis 80 and the longitudinal axis 90. Referring now to FIG. 9 the track pad 20 can have a body thickness H. The body thickness H can be measured along the normal axis 80 between either the first or second link engaging surface 112, 114 and the cavity portion 148 of the ground engaging surface 118. As shown in FIGS. 9 and 10, the track pad 20 can also have a channel height F measured along the normal axis 80 between the roller path surface 130 and either the first or second arm top surfaces 134, 138. FIG. 10 also illustrates a roller path thickness G measured along the normal axis 80 between the roller path surface 130 of the lug 116 and the cavity portion 148 of the ground engaging surface 118.

The ratios described in the following paragraphs between certain dimensional features of the track pad 20 are not meant to be exhaustive, but are merely examples of geometric ratios and relationships between dimensions of the track pad described above with reference to FIGS. 5-10 and otherwise disclosed herein. For instance, in some embodiments, a ratio between the body height E and a linking height J can be at least about 2:1, or at least 3:1 in other embodiments. In some embodiments, a ratio between the body height E and a linking height J can be in a range between about 2:1 and about 5:1. In other embodiments, a ratio between the body height E and a linking height J can be in a range between about 2:1 and about 4:1, or in a range between about 3:1 and about 4:1 in other embodiments. In some embodiments, a ratio between the body height E and a linking height J can be about 7:2.

In some embodiments, a ratio between the arm width B and the body width A can be at least about 1:10, or at least about 1:5 in other embodiments. In some embodiments, a ratio between the arm width B and the body width A can be in a range between about 1:10 and about 1:3. In some embodiments, a ratio between the arm width B and the body width A can be in a range between about 1:5 and about 1:3, or between about 1:5 and about 1:4 in other embodiments. In some embodiments, a ratio between the arm width B and the body width A can be at most about 1:3.

In some embodiments, a ratio between the body width A and the body length C can be at least about 5:3, at least about 5:2 in other embodiments, or at least about 3:1 in yet other embodiments. In some embodiments, a ratio between the body width A and the body length C can be at most about 4:1, or at most about 7:2 in other embodiments. In some embodiments, a ratio between the body width A and the body length C can be in a range between about 5:1 and about 1:1. In some embodiments, a ratio between the body width A and the body length C can be in a range between about 5:1 and about 2:1, or between about 5:1 and about 5:2 in other embodiments. In yet other embodiments, a ratio between the body width A and the body length C can be in a range between about 4:1 and about 3:1, or between about 7:2 and about 3:1 in other embodiments.

In some embodiments, a ratio between the body width A and the body height E can be at least about 2:1, or at least about 3:1 in other embodiments. In some embodiments, a ratio between the body width A and the body height E can be at most about 5:1, or at most about 4:1 in other embodiments. In some embodiments, a ratio between the body width A and the body height E can be in a range between about 1:1 and about 5:1, or between about 2:1 and about 4:1 in other embodiments. In some embodiments, a ratio between the body width A and the body height E can be in a range between about 3:1 and about 4:1, or between about 2:7 and about 4:1 in other embodiments.

In some embodiments, a ratio between the channel height F and the arm height D can be at least about 1:10, or at least about 1:3 in other embodiments. In some embodiments, a ratio between the channel height F and the arm height D can be at most about 1:1, or at most about 1:2 in other embodiments. In some embodiments, a ratio between the channel height F and the arm height D can be in a range between about 1:10 and about 1:1. In some embodiments, a ratio between the channel height F and the arm height D can be in a range between about 1:4 and about 3:4, or between about 1:4 and about 1:2 in other embodiments. In some embodiments, a ratio between the channel height F and the arm height D can be about 1:2.

In some embodiments, a ratio between the body thickness H and the linking height J can be at least about 1:10, or at least about 1:4 in other embodiments. In some embodiments, a ratio between the body thickness H and the linking height J can be at most about 3:5, or at most about 1:3 in other embodiments. In some embodiments, a ratio between the body thickness H and the linking height J can be in a range between about 1:10 and about 1:2, or between about 1:5 and about 2:5 in another embodiment. In some embodiments, a ratio between the body thickness H and the linking height J can be in a range between about 1:4 and about 1:3. In some embodiments, a ratio between the body thickness H and the linking height J can be about 1:3.

In some embodiments, a ratio between the roller path thickness G and the body height E can be at least about 1:10, or at least about 1:4 in other embodiments. In some embodiments, a ratio between the roller path thickness G and the body height E can be at most about 1:2, or at most about 1:3 in other embodiments. In some embodiments, a ratio between the roller path thickness G and the body height E can be in a range between about 1:10 and about 1:2, or between about 1:10 and about 1:3 in other embodiments. In some embodiments, a ratio between the roller path thickness G and the body height E can be in a range between about 1:5 and about 3:10, or between about 1:4 and about 3:10 in other embodiments. In some embodiments, a ratio between the roller path thickness G and the body height E can be about 1:4.

Track pads having the ratios of dimensions described herein can help maximize usable life of components making up track assemblies and minimizing weight and materials to the extent possible. Various embodiments of the track pad 20, for example, allow the track pad alone to contact other machine components, such as drive wheels, idlers, and rollers, without exposing the links in the endless chain to such wear.

While the arrangement is illustrated in connection with a hydraulic excavator, the arrangement disclosed herein has universal applicability in various other types of machines as well. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

### INDUSTRIAL APPLICABILITY

The present disclosure is applicable to any track-type mobile machine. However, the described track pad and track assembly may be particularly applicable to larger machines using track-type treads for motion, in which the forces passing through the track assembly are significant and can affect longevity of the track assembly. This may be particularly important to machines that operate substantially non-stop, where downtime of the machine to implement repairs and maintenance can be costly to the machine owner.

The disclosed track assembly and track pad may provide improved component longevity and improved ease of replacement and maintenance. The track pad described herein reduces the complexity of traditional crawler shoes by separating the track joint into a track pad that includes a lug with a roller path and a ground engaging surface in a single component, and separate the chain links. The track pad can have link engaging surfaces on either end where chain link assemblies can be fastened to the track pad. In the described track assembly, the chain links may serve pin joint function, but may not be contacted by other machine components such as sprockets, idlers, or rollers. Thus, more durable, sealed, and lubricated in joints are possible that are exposed to lower wear conditions throughout machine operation. Additionally, because the track pads are separate components from the links that comprise the chains, the track pads can be individually replaced by removing and replacing fasteners holding the track pads in place instead of deconstructing the entire tread. This can result in decreased machine downtime and increased machine efficiency.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A track pad for a machine having a track assembly, the track pad comprising:
a body having a top portion, a bottom portion, a first end portion, a second end portion, and a central portion between the first and second end portions;
a ground engaging surface defined on the bottom portion;
first and second substantially flat and co-planar link engaging surfaces defined on the top portion, the first link engaging surface being disposed at the first end portion and the second link engaging surface being disposed at the second end portion; and
a lug protruding from the central portion between the first and second link engaging surfaces, the lug extending above the first and second link engaging surfaces with respect to the ground engaging surface so as to periodically engage a drive wheel of the machine;
wherein at least one fastener hole is formed through the body between the first link engaging surface and the ground engaging surface and at least one fastener hole is formed through the body between the second link engaging surface and the ground engaging surface.

2. The track pad of claim 1, wherein a bottom cavity is formed into the bottom portion such that the ground engaging surface includes a cavity portion defined in the bottom cavity and an edge portion surrounding the bottom cavity.

3. The track pad of claim 2, wherein at least one fastener hole is formed through the body between the first link engaging surface and the cavity portion of the ground engaging surface and at least one fastener hole is formed through the body between the second link engaging surface and the cavity portion of the ground engaging surface.

4. The track pad of claim 1, wherein the lug includes a roller path surface disposed between first and second arms, the first and second arms extending above the roller path surface with respect to the first and second link engaging surfaces.

5. The track pad of claim 4, wherein the first arm includes a first arm base adjacent the first link engaging surface and tapers to a first arm top surface, and the second arm includes a second arm base adjacent the second link engaging surface and tapers to a second arm top surface.

6. The track pad of claim 5, wherein the first arm top surface and the second arm top surface are substantially co-planar.

7. The track pad of claim 6, further comprising a bottom cavity formed into the bottom portion such that the ground engaging surface includes a cavity portion defined in the bottom cavity and an edge portion surrounding the bottom cavity,
wherein a ratio between a body height, measured along a normal axis from the edge portion of the ground engaging surface to the first and second arm top surfaces, and a linking height, measured along the normal axis from the edge portion of the ground engaging surface to the first and second link engaging surfaces, is in a range between about 2:1 and about 5:1.

8. The track pad of claim 5, wherein a ratio between an arm width, measured along a lateral axis between the first arm top surface and the second arm top surface, and a body width, measured along the lateral axis, is in a range between about 1:10 and about 1:3.

9. The track pad of claim 1, wherein a ratio between a body width, measured along a lateral axis, and a body length, measured along a longitudinal axis, is in a range between about 5:1 and about 5:2.

10. A track assembly for a machine, the track assembly comprising:
a plurality of track pads, each track pad comprising a ground engaging surface opposite first and second co-planar link engaging surfaces, and a lug protruding between the link engaging surfaces above the link engaging surfaces with respect to the ground engaging surface, the lug configured to periodically engage a drive wheel of the machine;
a plurality of first and second pairs of links, the first pairs of links disposed on the first link engaging surfaces of the track pads and the second pairs of links disposed on the second link engaging surfaces of the track pads, the first and second pairs of links being disposed on opposite sides of the lugs from one another; and
a plurality of pins connecting adjacent first pairs of links end to end so as to form a first endless chain and connecting adjacent second pairs of links end to end so as to form a second endless chain;
wherein the first and second endless chains connect adjacent track pads in an endless loop.

11. The track assembly of claim 10, wherein at least one fastener hole is formed through each track pad between the first link engaging surface and the ground engaging surface and at least one fastener hole is formed through each track pad between the second link engaging surface and the ground engaging surface, and wherein at least one fastener fits through the at least one fastener hole to connect the first pairs of links to the first link engaging surface of each track pad and at least one fastener fits through the at least one fastener hole to connect the second pairs of links to the second link engaging surface of each track pad.

12. The track assembly of claim 10, wherein the lug of each track pad includes a roller path surface disposed between first and second arms, the first and second arms extending above the roller path surface with respect to the first and second link engaging surfaces.

13. The track assembly of claim 12, wherein the first arm of each track pad includes a first arm base adjacent the first link engaging surface and tapers to a first arm top surface, and the second arm of each track pad includes a second arm base adjacent the second link engaging surface and tapers to a second arm top surface.

14. The track assembly of claim 13, wherein the first arm top surface and the second arm top surface of each track pad are substantially co-planar.

15. The track assembly of claim 10, wherein each track pad includes a bottom cavity formed into the ground engaging surface.

16. The track assembly of claim 15, wherein the ground engaging surface includes a cavity portion defined in the bottom cavity and an edge portion surrounding the bottom cavity, and wherein at least one fastener hole is formed in each track pad between each of the first and second link engaging surfaces and the cavity portion of the ground engaging surface.

17. A track pad for a machine having a track assembly, the track pad comprising:
a body having a top portion, a bottom portion, a first end portion, a second end portion, and a central portion between the first and second end portions;
a ground engaging surface defined on the bottom portion, the ground engaging surface including a cavity portion defined in a bottom cavity formed into the bottom portion of the body and an edge portion surrounding the bottom cavity;
first and second substantially flat and co-planar link engaging surfaces defined on the top portion, the first link engaging surface being disposed at the first end portion and the second link engaging surface being disposed at the second end portion; and
a lug protruding from the central portion between the first and second link engaging surfaces, the lug extending above the first and second link engaging surfaces with respect to the ground engaging surface so as to periodically engage a drive wheel of the machine, the lug including:
a roller path surface disposed above the first and second link engaging surfaces with respect to the ground engaging surface, and
first and second arms that extend above the roller path surface, the first arm adjacent the first link engaging surface and the second arm adjacent the second link engaging surface such that the roller path surface is disposed between the first and second arms;
wherein at least one fastener hole is formed through the body between the first link engaging surface and the cavity portion of the ground engaging surface and at least one fastener hole is formed through the body between the second link engaging surface and cavity portion of the ground engaging surface.

18. The track pad of claim 17, wherein the first arm includes a first arm base adjacent the first link engaging surface and tapers to a first arm top surface, and the second arm includes a second arm base adjacent the second link engaging surface and tapers to a second arm top surface.

19. The track pad of claim 18, wherein the first arm top surface and the second arm top surface are substantially co-planar.

20. The track pad of claim 17 wherein a ratio between a body width, measured along a lateral axis, and a body length, measured along a longitudinal axis, is in a range between about 5:1 and about 5:2.
